(19) United States
(12) Patent Application Publication
(10) Pub. No.: US 2014/0185313 A1
(43) Pub. Date: Jul. 3, 2014

(54) FAN UNIT, ELECTRONIC APPARATUS, AND ENCLOSURE

(71) Applicant: FUJITSU LIMITED, Kawasaki-shi (JP)

(72) Inventor: Shohei HASHIMOTO, Yokohama (JP)

(73) Assignee: FUJITSU LIMITED, Kawasaki-shi (JP)

(21) Appl. No.: 14/200,617

(22) Filed: Mar. 7, 2014

Related U.S. Application Data
(63) Continuation of application No. PCT/JP2011/071016, filed on Sep. 14, 2011.

(51) Int. Cl. F04D 29/64; F21V 33/00

(52) U.S. Cl. CPC F04D 29/646; F21V 33/0096
USPC 362/555; 415/213.1; 361/679.01; 174/520; 362/253; 362/551

(57) ABSTRACT

An electronic apparatus includes a fan unit having a first connector part and a second connector part disposed at different positions, and a housing configured to accommodate the fan unit. The housing includes a connector and a connector protecting part. The connector is configured to be connected to one of the first and the second connector parts, and the connector protecting part is configured to cover the other one of the first and the second connector parts when the fan unit is inserted into the housing.

### CROSS-REFERENCE TO RELATED APPLICATIONS

This application is a continuation application of International Application PCT/JP2011/071016 filed on Sep. 14, 2011 and designates the U.S., the entire contents of which are incorporated herein by reference,

### FIELD

The disclosures discussed herein are related to a fan unit, an electronic apparatus, and an enclosure.

### BACKGROUND

Electronic apparatuses such as information processing apparatuses often incorporate fan units for cooling internal components. In general, the fan unit includes connectors for receiving electric power from an electric power supply. When the connectors of the fan unit are connected to connectors disposed inside the electronic apparatus, the fan unit is driven by receiving electric power from the power supply of the electronic apparatus.

The above-described fan unit is configured to be inserted into and withdrawn from the electronic apparatus. That is, the connectors of the fan unit are connected to connectors of the electronic apparatus simultaneously when the fan unit is incorporated inserted) into the electronic apparatus. Further, the connectors of the fan unit are disconnected from the connectors of the electronic apparatus simultaneously when the fan unit is removed (withdrawn) from the electronic apparatus. Thus, an inserting/withdrawing direction of the fan unit is a connecting direction of the connectors, which is restricted to one direction.

On the other hand, there are requests that the fan unit be inserted in a direction. (i.e., an inserting/withdrawing direction of the fan unit) differing from the connecting direction of the connectors so as to comply with the structure of the electronic apparatus. In order to meet such requests, two types of fan units having different structures of connecting directions of the connectors may need to be configured such that each of the connecting directions of the connectors match a corresponding one of the inserting/withdrawing directions of the two types of fan units in a case of the inserting/withdrawing direction being restricted to one direction.

Hence, there is proposed a fan unit having a structure capable of being inserted/withdrawn in two directions. The proposed fan unit includes a card edge portion such that the fan unit is, after the fan unit is inserted in a certain direction, moved in a direction differing from the certain direction so as to connect connectors of the fan unit to connectors of an electronic apparatus.

Further, the connectors of the electronic apparatus to be connected to the connectors of the fan unit may be disposed at different positions due to a structure of the electronic apparatus.

When the fan unit having a structure of being inserted into or withdrawn from the apparatus in one direction needs to be inserted or withdrawn in a different direction, another fan unit having a different structure may need to be prepared. Hence, manufacturing cost for the electronic apparatus into which the fan unit is to be incorporated may be increased.

Further, when the fan unit has a structure of connecting connectors of the an unit to the connectors of the electronic apparatus by moving the fan unit in two directions, the electronic apparatus may need to be provided extra space for allowing the fan unit to move in the second direction, within, the electronic apparatus. Hence, the size of the electronic apparatus may be increased for acquiring the extra space.

### RELATED ART DOCUMENTS

### Patent Documents

Patent Document 1 Japanese Laid-open Patent Publication No. 2001-339189
Patent Document 2: Japanese, Laid-open Patent Publication No. 9-199881
Patent Document 3: Japanese Patent No. 4354462

### SUMMARY

According to an aspect of an embodiment, there is provided an electronic apparatus that includes a fan unit having a first connector part and a second connector part disposed at different positions; and a housing configured to accommodate the fan unit. In the electronic apparatus, the housing includes a connector and a connector protecting part. The connector is configured to be connected to one of the first and the second connector parts, and the connector protecting part is configured to cover the other one of the first and the second connector parts when the fan unit is inserted into the housing.

The object and advantages of the invention will be realized and attained by means of the elements and combinations particularly pointed out in the appended claims.

It is to be understood that both the foregoing general description and the following detailed description are exemplary and explanatory and are not restrictive of the invention as claimed.

### BRIEF DESCRIPTION OF DRAWINGS

FIG. 1 is a perspective view of a fan unit according to an embodiment;

FIG. 2 is a perspective view of the fan unit according to the embodiment;

FIG. 3 is a perspective view of the fan unit according to the embodiment;

FIG. 4 is a perspective view of the fan unit according to the embodiment;

FIG. 5A is a front view of a unit frame;

FIG. 5B is a side view of the unit frame;

FIG. 5C is a side view of the unit frame;

FIG. 6 is a diagram illustrating respective connecting directions of two connector parts;

FIG. 7 is a perspective view illustrating a rear part of an electronic apparatus into which the fan unit is incorporated in a horizontal direction;

FIG. 8 is a perspective view illustrating the fan unit before being inserted into a housing of the electronic apparatus;

FIG. 9 is a perspective view illustrating the fan unit and the inside of the housing of the electronic apparatus;

FIG. 10 is a perspective view of a fan unit mounting part;

FIG. 11 is a rear view of an electronic apparatus into which the fan unit is incorporated in a vertical direction;

FIG. 12 is a perspective view illustrating the inside the electronic apparatus illustrated in FIG. 11;

FIG. 13 is a perspective view depicted by enlarging a part of the fan unit mounting part; and

FIG. 14 is a perspective view of the fan unit mounting part.

### DESCRIPTION OF EMBODIMENTS

It is desirable to provide a fan unit capable of being inserted into or withdrawn from two types of electronic apparatuses having respective, connectors at different positions, and an electronic apparatus having such a fan unit.

In the following, preferred embodiments are described with reference to the accompanying drawings.

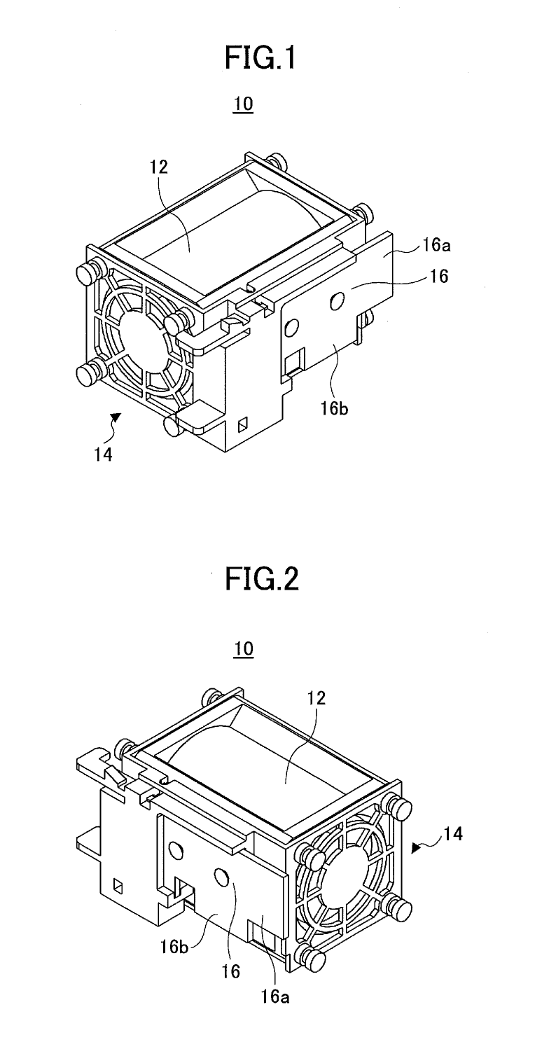

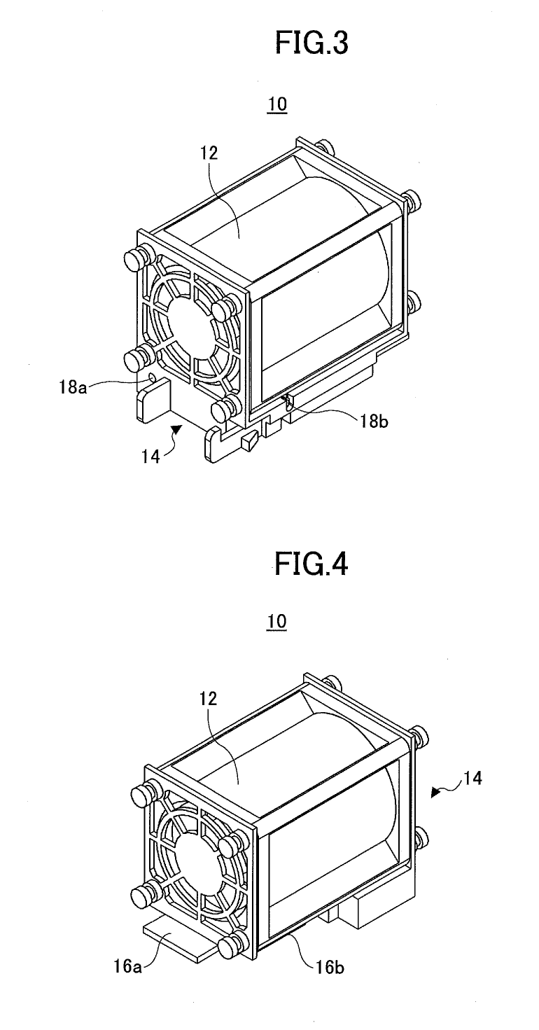

Initially, illustration is given of a fan unit according to an embodiment. FIGS. 1 to 4 are each perspective views of a fan unit 10 according to an embodiment.

The fan unit 10 includes fan 12, a unit frame 14 supporting the fan 12, and a printed circuit board 16 attached to the unit frame 14. The fan 12 incorporating a motor is accommodated inside the U-shaped unit frame 14. The printed circuit board 16 serves as a circuit board configured to control a drive current to be supplied to the fan 12. The printed circuit board 16 includes a connector part 16a and a connector part 16b serving as a first connecting part and the second connecting part, respectively. The connector part 16a and the connector part 16b fit into respective connectors of the electronic apparatus as will be described later.

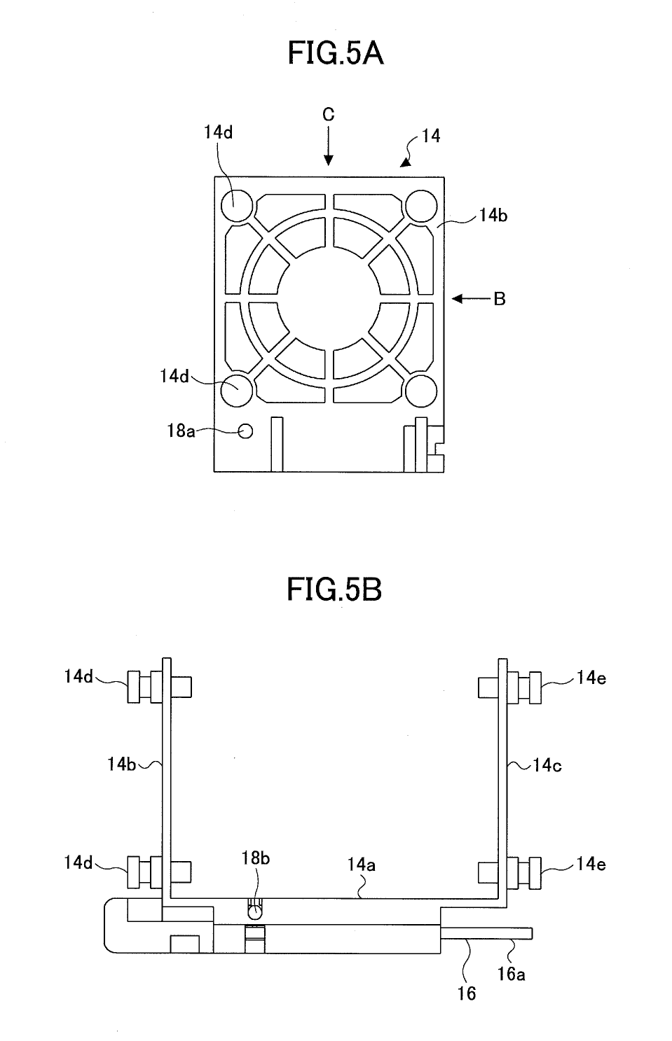

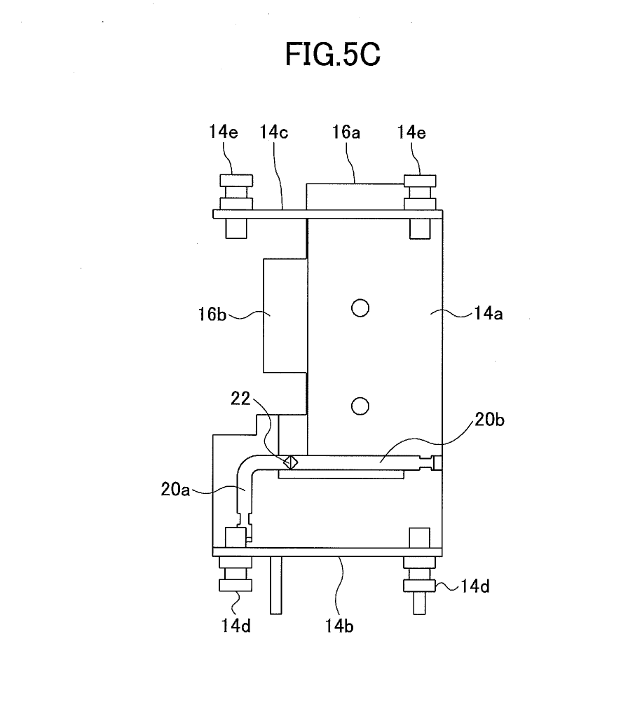

FIG. 5A is a front view of a unit frame 14. FIG. 5B is a side view of the unit frame 14 viewed from an arrow B direction. FIG. 5C is a side view of the unit frame 14 viewed from an arrow C direction. The unit frame 14 has, as illustrated in FIG. 5B, a U-shape when viewed from a lateral side. The unit frame 14 has a base plate 14a, a front plate 14b, and a rear plate 14c. The front plate 14b is configured to vertically extend from a front end of the base plate 14a, and the rear plate 14c, is configured to vertically extend from a rear end of the base plate 14a.

The base plate 14a, the front plate 14b, and the rear plate 14c form a space configured to accommodate a fan 12. The fan 12 is fixed to the unit frame 14 via four fan fixing parts 14d attached to the front plate 14b and four fan fixing parts 14e attached to the rear plate 14c.

The printed circuit board 16 is attached to the base plate 14a of the unit frame 14. The connector part 16a serving as a first connecting part of the printed circuit board 16 is configured to extend beneath the rear plate 14c, and an extending end of the connector part 16a is configured to face in a rear side direction. On the other hand, the connector part 16b serving as a second connecting part of the printed circuit board 16 is configured to extend between the front plate 14b and the rear plate 14c, and an extending end of the connector part 16b is configured to face in a lateral side direction. Hence, a connecting direction of the connector part 16a is a longitudinal direction of the fan unit 14 (i.e., a direction from the front plate 14b to the rear plate 14c), and a connecting direction of the connector part 16b is a lateral direction of the tan unit 10 (a direction orthogonal to the longitudinal direction). The connector part 16a and the connector part 16b have the same shape and the same electric function, and hence, whichever of the connectors 16a and 16b is connected to the connector of the electronic apparatus, the fan unit 10 may be driven and controlled in the same manner.

The front plate 14b of the unit frame 14 is provided with a front light-emitting part 18a serving a first light-emitting part. Further, the base plate 14a of the unit frame 14 is provided with a side light-emitting part 18b serving as a second light-emitting part. That is, the front light-emitting part 18a is disposed in the front side of the fan unit 10, and the side light-emitting part 18b is disposed in the lateral side orthogonal to the front side of the fan unit 10. The front light-emitting part 18a serves, as illustrated in FIG. 5C, as an end face of a light pipe 20a. An end face on the other side of the light pipe 20a is configured to face an LED (light-emitting diode) 22 mounted on the printed circuit board 16. Hence, when the LED 22 emits light, light emitted from the LED 22 is propagated via the light pipe 20a to the front light-emitting part 18a, thereby causing the front light-emitting part 18a to emit light. Likewise, the side light-emitting part 18b serves, as illustrated in FIG. 5C, as an end face of a light pipe 20b. An end face on the other side, of the light pipe 20b is configured to face the LED 22 mounted on the printed circuit board 16. Hence, when the LED 22 emits light, light emitted from the LED 22 is propagated via the light pipe 20b to the side light-emitting part 18b, thereby causing the side light-emitting part 18b to emit light. As described above, both the front light-emitting part 18a and the side light-emitting part 18b may emit light by turning on the LED 22 serving as a single light source.

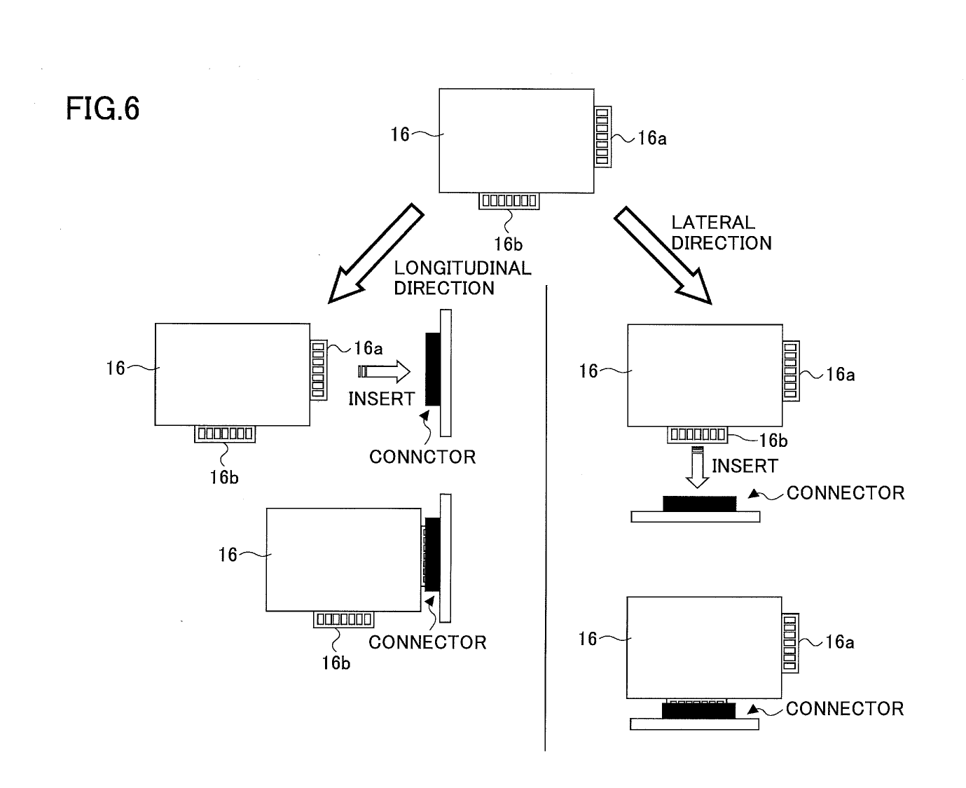

Below is a description given of connections of the connector parts 16a and 16b of the fan unit 10 according to the embodiment. FIG. 6 is a diagram illustrating respective connecting directions of two connector parts. As described above, the connector part 16a serving as the first connecting part of the printed circuit board 16 is configured to face the rear side of the fan unit 10. Hence, when the fan unit 10 (i.e., the printed circuit board 16) is moved in a longitudinal direction to be inserted in the electronic apparatus, a moving direction of the fan unit 10 (i.e., a moving direction of the printed circuit board 16) matches a connecting direction of the connector part 16a. Hence, when the fan unit 10 (i.e., the printed circuit board 16) is moved in a longitudinal direction to be inserted in the electronic apparatus, the connector part 16a is connected to a connector of the electronic apparatus as illustrated on the left hand side of FIG. 6.

On the other hand, when the fan, unit 10 (i.e., the printed circuit board 16) is moved in a lateral direction to be inserted in the electronic apparatus, a moving direction of the fan unit 10 (i.e., a moving direction of the printed circuit board 16) matches a connecting direction of the connector part 16b. Hence, when the fan unit 10 (i.e., the printed circuit board 16) is moved in a lateral direction to be inserted in the electronic apparatus, the connector part 16b is connected to a connector of the electronic apparatus as illustrated on the right hand side of FIG. 6.

Note that the connector part 16a or 16b not used for the connection is configured to be covered with components of the electronic apparatus. The components of the electronic apparatus for covering the unused connector part 16a or 16b will be described later.

As described above, the fan unit 10 includes two connector parts (i.e., the connector part 16a and the connector part 16b) having the same function. Hence, even when inserting directions of electronic apparatuses vary, one of the connector parts that matches the inserting direction of a corresponding one of the electronic apparatuses may be used. Hence, one fan unit 10 may be inserted into either of two different types of the electronic apparatuses having different inserting directions.

Next, a description is given of a structure of the electronic apparatus into which the above-described fan unit 10 is inserted, and operations for inserting the fan unit 10 into the electronic apparatus.

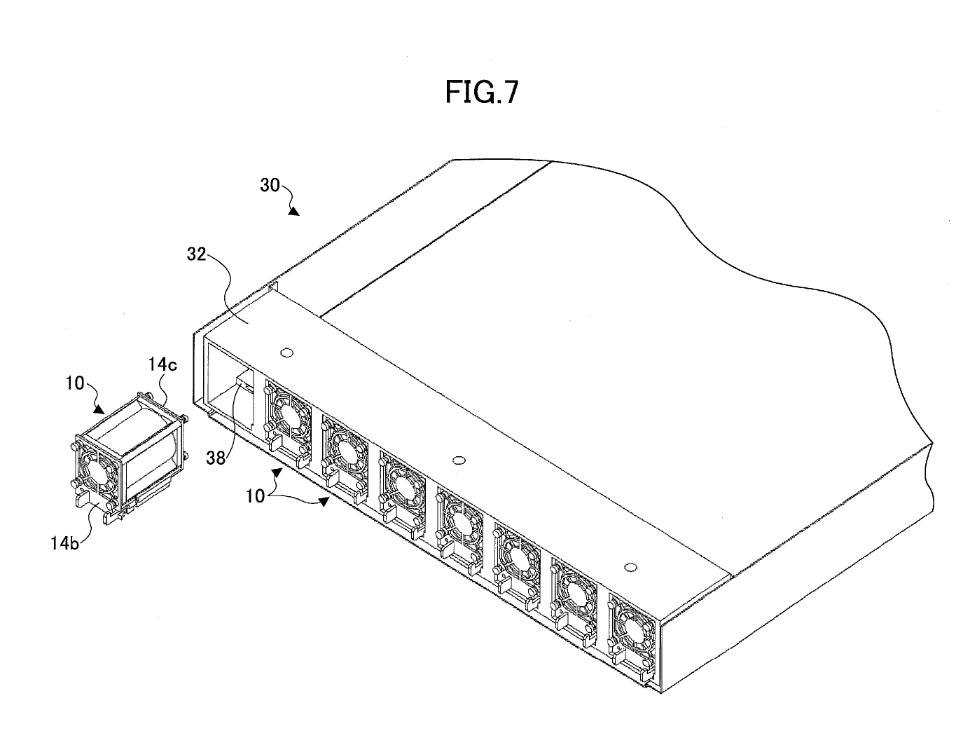

First, illustration is given of an electronic apparatus into which the fan unit 10 is inserted in a horizontal direction. FIG. 7 is perspective view illustrating a rear part of an electronic apparatus 30 into which the fan unit 10 is incorporated in a horizontal direction. FIG. 7 illustrates an enclosure of the electronic apparatus from which a top cover is removed, and internal electronic components and the like are omitted from FIG. 7 for simplifying illustration. The rear part of the electronic apparatus 30 is provided with a fan unit mounting part 32 for accommodating plural fan units 10.

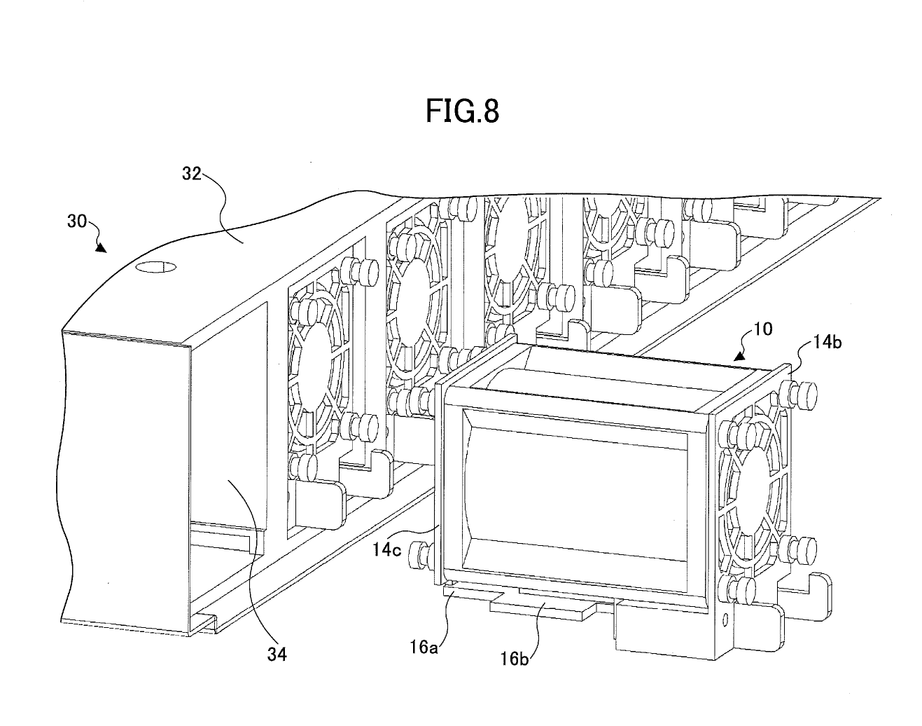

The fan unit mounting part 32 is a frame-like member that includes plural housings 34 (see FIG. 8) for housing the respective fan units 10. FIG. 7 illustrates a state before one of the fan units 10 is attached to a corresponding one of the housings 34 of the fan unit mounting part 32. The fan unit 10 is inserted from a rear side the rear plate 14c side of the unit frame 14) into the housing 34.

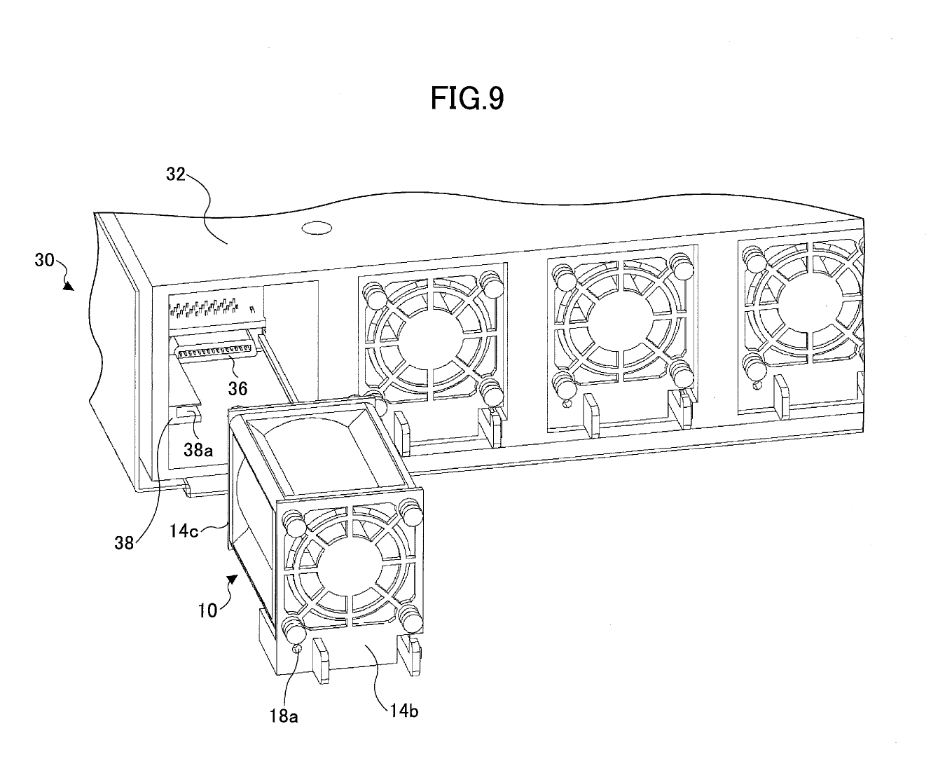

FIG. 8 is a perspective view illustrating the fan unit 10 before being inserted into the housing 34 of the electronic apparatus 30. FIG. 9 is a perspective view illustrating the fan unit 10 and the inside of the housing 34 of the electronic apparatus 30. The fan unit 10 is inserted from the rear plate 14c side into the housing 34 of the fan unit mounting part 32. Accordingly, an inserting direction of the fan unit 10 into the housing 34 matches a connecting direction of the connector part 16a.

As illustrated in FIG. 9, a connector 36 of the electronic apparatus 30 is disposed in the housing 34. The connector 36 is disposed at a position that faces the connector part 16a of the fan unit 10. Hence, when the fan unit 10 is inserted into the housing 34 of the electronic apparatus 30 to incorporate the fan unit 10 into the electronic apparatus 30, the connector part 16a disposed on the printed circuit board 16 of the fan unit 10 fits into the connector 36 of the electronic apparatus 30. As a result, the connector part 16a of the fan unit 10 is connected to the connector 36 of the electronic apparatus 30. That is, when the fan unit 10 of the electronic apparatus 30 is inserted into the housing 34, the connector part 16a is automatically connected to the connector 36. Hence, power and a control signal may be transmitted from the electronic apparatus 30 to the printed circuit board 16 of the fan unit 10 via the connector 36 and the connector part 16a.

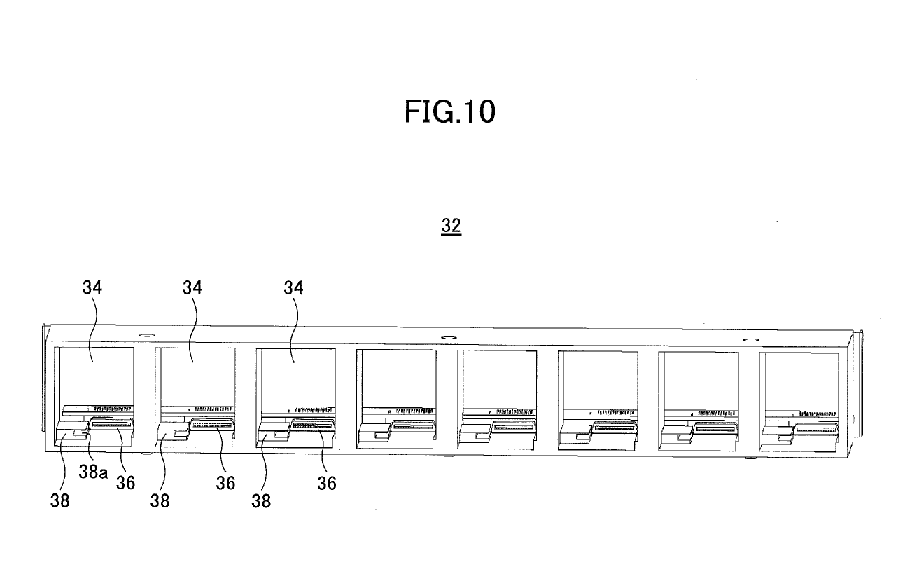

Note that the connector part 16b of the fan unit 10 is not connected to any of connectors such that the connector part 16b is exposed (remains uncovered) inside the housing 34. Thus, a connector protecting part 38 is disposed inside the housing 34 disposed in the fan unit mounting part 32 of the electronic apparatus 30. FIG. 10 is a perspective view of the fan unit mounting part 32. The connector protecting part 38 includes a groove 38a into which the connector part 151D is inserted. The groove 28a has a size large enough to cover an entire terminal of the connector part 16b, such that the connector protecting part 38 serves as a protector of the connector part 15b.

As described above, when the fan unit 10 is inserted into the housing 34, the connector part 16b is inserted into the groove 38a of the connector protecting part 38, and the terminal of the connector part 15b is covered with the connector protecting part 38. Accordingly, the terminal of the connector part 16b is prevented from being touched unexpectedly or accidentally, and the connector part 16b may thus be protected.

When the connector part 16a of the fan unit 10 is connected to the connector 25 of the housing 34 of the electronic apparatus 30, power is supplied from the electronic apparatus 30 to the printed circuit board 16, which causes the LED 22 mounted on the printed circuit board to emit light. Light from the LED 22 reaches the front light-emitting part 18a via the light pipe 20a, which causes the front light-emitting part 18a to emit light. For example, when a red LED is set as the LED 22, the front light-emitting part 18a is configured to emit red light. The emission of light from the front light-emitting part 18a may serve as a mark for an operator. That is, when the operator removes the fan unit 10 from the electronic apparatus 20, the operator is able to withdraw the fan unit 10 by directing a head of the fan unit 10 toward the front plate 14b in which the light emitting front light-emitting part 18a resides.

Note, that when the LED 22 emits light, light emitted from the LED 22 is also propagated via the light pipe 20b to the side light-emitting part 18b, thereby causing the side light-emitting part 18b to emit light. Note that in a state where the unit 10 is inserted into the housing 34, the side light-emitting part 18b is located inside, the housing 34, and is hence unobservable by the operator. Accordingly, the operator may be able to observe emission of light from the front light-emitting part 18a alone, which may facilitate the operator checking a withdrawing direction of the fan unit 10 by monitoring the front light-emitting part 18a with the naked eye.

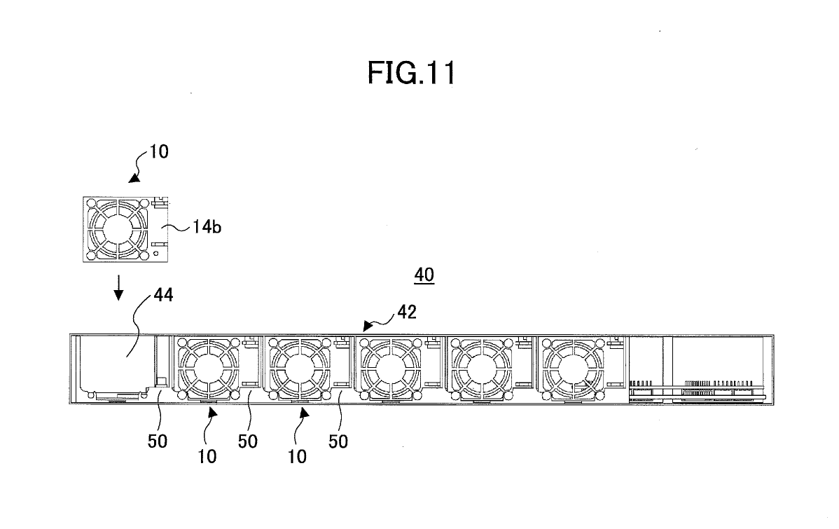

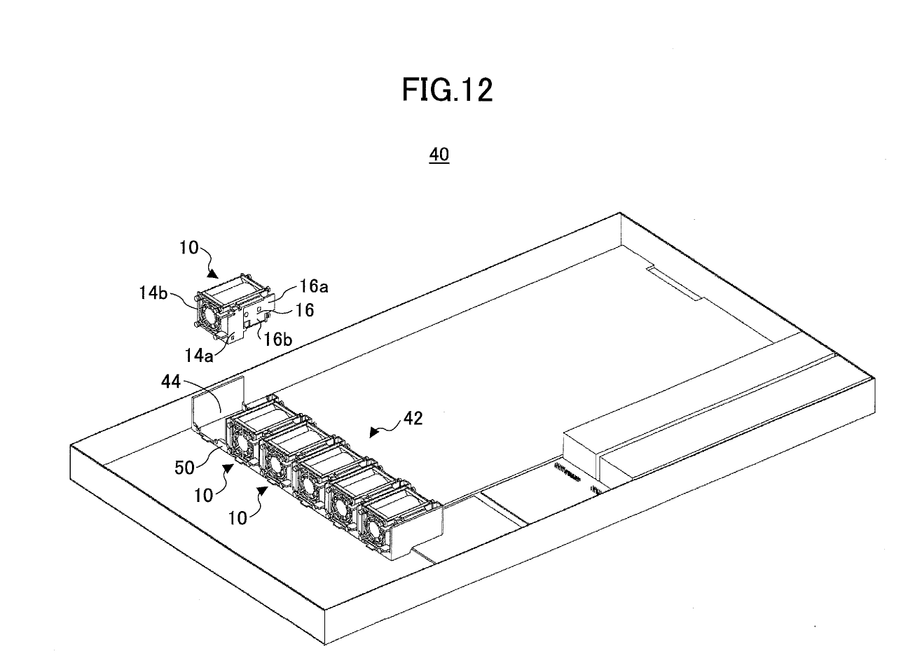

Next, illustration is given of an electronic: apparatus into which the fan unit 10 is inserted in a vertical direction. FIG. 11 is a rear view of an electronic apparatus 40 to which the fan unit 10 is incorporated in a vertical direction. FIG. 12 is a perspective view illustrating the inside of the electronic apparatus 40. Internal electronic components and the like are omitted from FIG. 12 for simplifying illustration. A fan unit mounting part 42 for accommodating plural fan units 10 is disposed inside the electronic apparatus 40. The fan unit mounting part 42 is an open-top frame-like member that includes plural housings 44 for housing the respective fan units 10, FIGS. 11 and 12 each illustrate a state before one of the fan units 10 is attached to a corresponding one of the housings 44 of the fan unit mounting part 42.

The fan unit 10 is inserted from a lateral side (a lateral side of the unit frame 14) into the housing 44. That is the fan unit 10 is inserted into the housing 44 of the fan unit mounting part 42 in a state where the front plate 14b of the unit frame 14 faces in a rear side direction, and the base plate 14a of the unit frame 14 faces in a lateral direction.

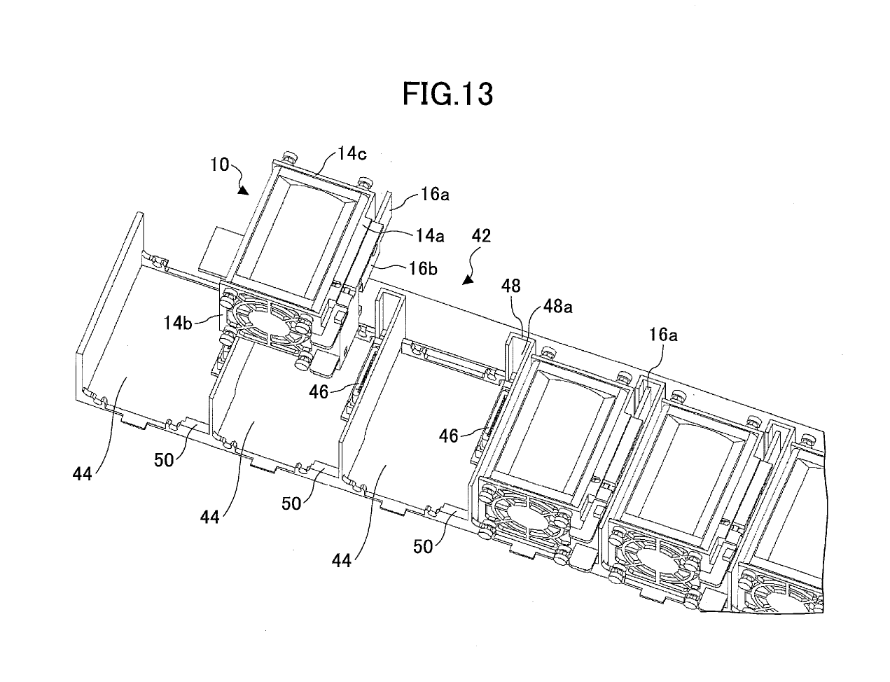

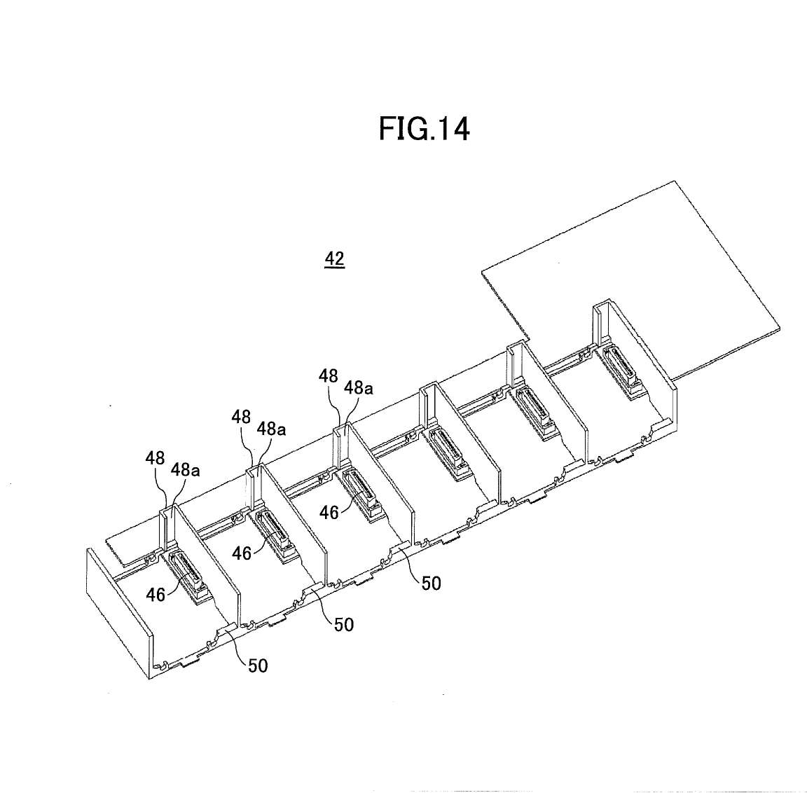

FIG. 13 is a perspective view depicted by enlarging a part of the fan unit mounting part 42. FIG. 14 is a perspective view of the fan unit mounting part 42. The fan unit mounting part 42 includes the plural housings 44, and connectors 46 of the electronic apparatus are disposed in the respective housings 44. The connector 46 is disposed at a position that faces the connector part 16b of the fan unit 10. Hence, when the fan unit 10 is inserted into the housing 44 of the electronic apparatus 40 to incorporate the fan unit 10 into the electronic apparatus 40, the connector part 16b disposed on the printed circuit board 16 of the fan unit 10 fits into the connector 46 of the electronic apparatus 40. As a result, the connector part 16b of the fan unit 10 is connected to the connector 46 of the electronic apparatus 40. That is, when the fan unit 10 of the electronic apparatus 40 is inserted into the housing 44, the connector part 16b is automatically connected to the connector 46. Hence, power and a control signal may be transmitted from the electronic apparatus 40 to the printed circuit board 16 of the fan unit 10 via the connector 46 and the connector part 16b.

Note: that the connector part 14a of the fan unit 10 is not connected to any of connectors such that the connector part 16a is exposed (remains uncovered) inside the housing 44. Thus, a connector protecting part 48 is arranged inside the housing 44 that is disposed in the fan unit mounting part 42 of the electronic apparatus 40. The connector protecting part 48 includes a groove 48a into which the connector 16a is inserted. The groove 48a has a size large enough to cover an entire terminal of the connector part 16a, such that the connector protecting part 48 serves as a protector of the connector part 16a.

As described above, when the fan unit 10 is inserted into the housing 44, the connector part 16a is inserted into the groove 48a of the connector protecting part 48, and the terminal of the connector 16a is covered with the connector protecting part 48. Accordingly, the terminal of the connector part 16a is prevented from being touched unexpectedly or accidentally, and the connector 16a may thus be protected.

When the connector part 16b of the fan unit 10 is connected to the connector 46 of the housing 44 of the electronic apparatus 40, power is supplied from the electronic apparatus 40 to the printed circuit board 16, which causes the LED 22 mounted on the printed circuit board to emit light. Light from the LED 22 reaches the side light-emitting part 18b via the light pipe 20b, which causes the side light emitting part 18b to emit light. For example, when a red LED is set as the LED 22, the side light-emitting part 18b is configured to emit red light. The emission of light from the side light-emitting part 18b may serve as a mark for an operator. That is, when the operator removes the fan unit 10 from the electronic apparatus 40, the operator is able to withdraw the fan unit 10 in a direction of the light emitting side light-emitting part 18b.

Note that when the LED 22 emits light, light emitted from the LED 22 is also propagated via the light pipe 20a to the front light-emitting part 18a, thereby causing the front light-emitting part 18a to emit light. Note that in a state where the fan unit 10 is inserted into the housing 44, the front light-emitting part 18a is covered with an interceptor 50 disposed inside the housing 34, and is hence unobservable by the operator. Accordingly, the operator may be able to observe emission of light from the side light-emitting part 18b alone, which may facilitate the operator's checking a withdrawing direction of the fan unit 10 by monitoring the side light-emitting part 18b with the naked eye.

The above embodiments have described an example of the fan unit capable of being inserted into or withdrawn from the two types of electronic apparatuses having connectors of different connecting directions. However, the example of such a fan unit may also be applied to two types of electronic apparatuses having connectors of the same connecting directions at different positions. That is, connector parts may be disposed on the printed circuit board 16 of the fan unit 10 such that the positions of the connector parts of the fan unit 10 match respective positions of the connectors disposed at different positions of the electronic apparatuses. Then, protecting parts may be disposed at respective positions of the electronic apparatuses so as to match the positions of unused connector parts on the printed circuit board 16 of the fan unit 10, which enables one fan unit to be incorporated into the plural electronic apparatuses having connectors at different positions.

According to an aspect of an embodiment, there is provided an electronic apparatus that includes a fan unit having a first connector part and a second connector part disposed at different positions; and a housing configured to accommodate the fan unit. In the electronic apparatus, the housing includes a connector and a connector protecting part. The connector is configured to be connected to one of the first and the second connector parts, and the connector protecting part is configured to cover the other one of the first and the second connector parts when the fan unit is inserted into the housing.

According to another aspect of an embodiment, there is provided a fan unit that includes a fan; a circuit board on which an electronic circuit configured to drive the fan is disposed; a first connecting part disposed at a first position of the circuit board; and a second connecting part disposed at a second position of the circuit hoard. In the fan unit, the first connecting part and the second connecting part include the same shape and the same connecting function, and one of the first and the second connecting parts is capable of being inserted into or withdrawn from a connector of a connecting destination.

According to still another aspect of an embodiment, there is provided an enclosure of an electronic apparatus. The enclosure includes a housing configured to accommodate a fan unit having a first connecting part and a second connecting part. The housing includes a connector and a connector protecting part. The connector being configured to be connected to one of the first and the second connector parts, and the connector protecting part is configured to cover the other one of the first and the second connector parts when the fan unit is inserted into the housing.

The present invention is not limited to specific examples disclosed above, and various alterations or modifications may be made without departing from the scope of the invention.

The embodiments may be applied to the electronic apparatus incorporating the removable fan unit.

According to the embodiments, one fan unit may be inserted into or withdrawn from the two electronic apparatuses having connectors at different positions.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority or inferiority of the invention. Although the embodiments of the present invention have been described in detail, it should be understood that the various changes, substitutions, and alterations could be made hereto without departing from the spirit and scope of the invention.

What is claimed is:

1. An electronic apparatus, comprising:
a fan unit having a first connector part and a second connector part disposed at different positions; and
a housing configured to accommodate the fan unit, wherein
the housing includes a connector and a connector protecting part, wherein
the connector is configured to be connected to one of the first and the second connector parts,
and the connector protecting part is configured to cover the other one of the first and the second connector parts when the fan unit is inserted into the housing.

2. The electronic apparatus as claimed in claim 1, wherein
the fan unit includes;
a first light emitting part disposed on a first surface, and
a second light-emitting part disposed on a second surface differing from the first surface.

3. The electronic apparatus as claimed in claim wherein;
light is propagated from a single light source via a light pipe to the first and the second light-emitting parts.

4. The electronic apparatus as claimed in claim 3, wherein
the light source includes an LED mounted on a circuit board disposed on the fan unit.

5. A fan unit comprising:
a fan;
a circuit board on which an electronic circuit configured to drive the fan is disposed;
a first connecting part disposed at a first position of the circuit board; and
a second connecting part disposed at a second position of the circuit board, wherein;
the first connecting part and the second connecting part include the same shape and the same connecting function, and one of the first and the second connecting parts is capable of being inserted into or withdrawn from a connector of a connecting destination.

6. The fan unit as claimed in claim 5, further comprising:
a first light-emitting part in a first surface disposed at an opposite side, of the first connecting part; and
a second light-emitting part in a second surface orthogonal to the first surface.

7. The fan unit as claimed in claim 6, further comprising:
a light source;
a first light pipe configured to propagate light from the light source to the first light-emitting part; and
a second light pipe configured to propagate light from the light source to the second light-emitting part.

8. The an unit as claimed in claim 7, wherein;
the light source is an LED mounted on the circuit board.

9. An enclosure of an electronic apparatus, the enclosure, comprising:
a housing configured to accommodate a fan unit having a first connecting part and a second connecting part, wherein;
the housing includes a connector and a connector protecting part, wherein
the connector is configured to be connected; to one of the first and the second connector parts, and the connector protecting part is configured to cover the other one of the first and the second connector parts when the fan unit is inserted into the housing.
